(19) United States
(12) Patent Application Publication
(10) Pub. No.: US 2011/0017721 A1
(43) Pub. Date: Jan. 27, 2011

(54) Filament Supporter and Tube Heater, Electric Hob Having the Same

(76) Inventors: Young-Jun Lee, Seoul (KR); Byeong-Wook Park, Seoul (KR); Yang-Kyeong Kim, Seoul (KR)

Correspondence Address: MCKENNA LONG & ALDRIDGE LLP, 1900 K STREET, NW, WASHINGTON, DC, 20006, US

(21) Appl. No.: 12/933,045

(22) PCT Filed: Mar. 16, 2009
(86) PCT No.: PCT/KR2009/001300

§ 371 Date: Sep. 16, 2010

(30) Foreign Application Priority Data
Mar. 17, 2008 (KR) 10-2008-00242234

(51) Int. Cl. H05B 3/68; H05B 3/40

(52) U.S. Cl. 219/452.11; 219/534

(57) ABSTRACT

The present invention relates to a filament supporter and a tube heater having the same. In the present invention, the contact between a tube and a filament is prevented by the filament supporter. Accordingly, according to the present invention, there is an advantage in that the filament is efficiently prevented from being contacted to the tube.

### TECHNICAL FIELD

The present invention relates to a filament supporter for supporting a filament and a tube heater, electric hob having the same.

### BACKGROUND ART

Generally, electric heaters are devices that convert electric energy into heat energy. A tube heater of these electric heaters generates heat, as a filament provided in a tube is heated by an electric current. A quartz tube is used as the tube and a carbon filament is used as the filament, a vacuum state may be maintained in the tube or an inert gas such as a halogen may be filled therein.

In the past, the filament is prevented from being contacted with an inner circumferential surface of the tube by applying tensile force to the filament. This is to prevent the phenomenon that a crystal is formed at a surface of the tube by a devitrification phenomenon, as the filament generating high-temperature heat and the tube are contacted to each other.

### DISCLOSURE OF INVENTION

### Technical Problem

However, this conventional art has the following problems.

As described above, according to the prior art, although the filament is prevented from being contacted with the tube by applying tensile force to the filament, however the filament may be contacted with the inner circumferential surface of the tube since the filament itself is tensioned. Therefore, as described above, as the crystal is formed at the surface of the tube by the devitrification phenomenon, there will be a disadvantage in that the heat generated by the filament cannot be efficiently transferred to an object to be heated.

### Technical Solution

The present invention is to solve the above conventional problems, and has an object to provide a filament supporter and a tube heater having the same, which is configured to prevent a filament from being contacted to the tube.

To achieve these objects, and other advantages and in accordance with the purpose of the invention as embodied and briefly described herein, there is provided a tube heater including: a tube; a filament which is provided in the tube and generates heat by its electric resistance; and a filament supporter which is provided between the tube and the filament and prevents a phenomenon that heat generated by the filament is transferred to the tube, as it is formed of material having thermal resistance.

In another aspect of the present invention, there is provided a tube heater including: a tube; a filament which is provided in the tube and generates heat by its electric resistance; and a filament supporter having a tube contacting part which is contacted to the tube and a filament fixing part which is extended from the tube contacting part and is fixed to the filament.

In further another aspect of the present invention, there is provided a tube heater including: a tube; a filament which is provided in the tube and generates heat by its electric resistance; and a filament supporter where at least some of an outer circumferential surface of the filament supporter is contacted to an inner circumferential surface of the tube, and at least some of an inner circumferential surface of the filament supporter is contacted to an outer circumferential surface of the filament.

### Advantageous Effects

According to the embodiments of the present invention, the contact of an inner circumferential surface of the tube 11 and the filament 13 is prevented by the filament supporter 15. Therefore, the generation of the devitrification phenomenon, where a crystal is formed at the surface of the tube 11 as the heat of the filament is transferred to the tube 11, is prevented even though the filament 13 generates heat. And, by means of the prevention of this devitrification phenomenon, a heat loss caused during the heat transfer process, where the heat of the heater generated by the filament 13 is transferred to the object to be heated via the tube 11, can be substantially prevented.

According to the embodiments of the present invention, the outer circumferential surface of the filament 23 is prevented from contacting to the inner circumferential surface of the tube 21 by the filament supporter 25 formed of material having thermal resistance. Also, the area of contact between the inner circumferential surface of the tube 21 and the outer circumferential surface of the filament 23 is minimized by the contact projections 27. Therefore, according to the present embodiment, since the heat of the heater generated by the filament 23 is efficiently prevented from transferring to the tube 21, the crystal formation on the tube 21 due to the devitrification phenomenon and the heat loss of the heat transfer process can be effectively prevented.

According to the embodiments of the present invention, the devitrification phenomenon, in which a crystal is formed at the tube 31, 41 as the heat of heater generated by the filament 33, 43, is minimized. Also, the heat loss, which is generated by the devitrification phenomenon while transferring the heat of the heater, is efficiently prevented

### BRIEF DESCRIPTION OF THE DRAWINGS

FIG. 1 is a perspective view showing main parts of a tube heater according to a first embodiment of the present invention.

FIG. 2 is a longitudinal cross-sectional view showing main parts according to the first embodiment of the present invention.

FIG. 3 is a perspective view showing main parts of a tube heater according to a second embodiment of the present invention.

FIG. 4 is a longitudinal cross-sectional view showing main parts according to the second embodiment of the present invention.

FIG. 5 is a longitudinal cross-sectional view showing main parts according to a third embodiment of the present invention.

FIG. 6 is a longitudinal cross-sectional view showing main parts according to a fourth embodiment of the present invention.

### MODE FOR THE INVENTION

Hereinafter, a first embodiment of a tube heater according to the present invention will be explained in detail with reference to the accompanying drawings.

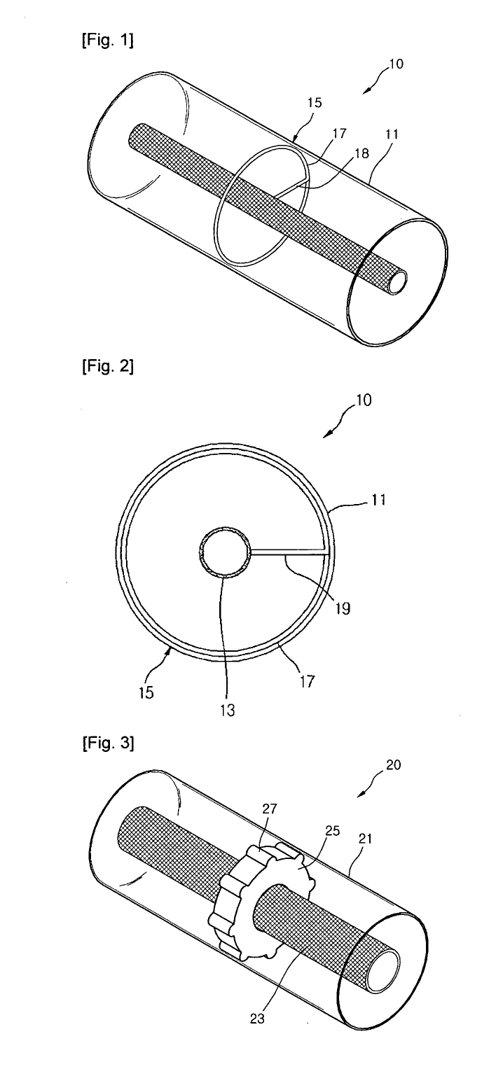

FIG. 1 shows main parts of a tube heater according to a first embodiment of the present invention in a perspective view, and FIG. 2 shows main parts according to the first embodiment of the present invention in a longitudinal cross-sectional view.

Referring to FIGS. 1 and 2, the tube heater 10 according to the present embodiment includes a tube 11, a filament 13 and at least one filament supporter 15. For example, a quartz tube is used as the tube 11. And, the filament may be, for example, formed in a linear shape or a tubular shape by the weaving of a carbon yarn. The filament 13 is provided in the tube 11. And, after the filament 13 is provided therein, the inside of the tube 11 is vacuumed or is filled with an inert gas.

The filament supporter 15 serves to prevent the filament 13 from contacting to the tube 11. In other words, the filament supporter 15 holds the filament so that an inner circumferential surface of the tube and the filament 13 are spaced apart at a predetermined interval. For this end, the filament supporter 15 includes a tube contacting part 17 and a filament fixing part 19.

The tube contacting part 17 is formed in the shape of a ring which is contacted to the inner circumferential surface of the tube 11. Therefore, an outer diameter of the tube contacting part 17 is determined to correspond to an inner diameter of the tube 11.

The filament fixing part 19 is a portion that is contacted to the filament 13. The filament fixing part 19 is extended from one side of the tube contacting part 17 toward the center of a circle of the tube contacting part 17 in a predetermined length. And, a tip of the filament fixing part 19 is inserted between carbon yarns of the filament 13.

Meanwhile, the filament supporter 15, i.e. the tube contacting part 17 and the filament fixing part 19 may be integrally formed by bending one element. That is, the tube contacting part 17 is formed by bending the element in the shape of a ring in order to have an outer diameter corresponding to an inner diameter of the tube 11, and the filament fixing part 19 is formed by extending one end of the element from the tube contacting part 17 toward the center of a circle thereof. However, the filament supporter 15 may also be formed by fixing the separate filament fixing part 19 to one side of the separate tube contacting part 17. In addition, according to the present embodiment, the filament supporter 15 may be formed of materials including metals having specific thermal resistance, for example Mo or W.

Hereinafter, the operation of the tube heater according to the first embodiment of the present invention will be explained in detail.

First, if electric power is applied to the filament 13, heat of the heater will be produced, as the filament 13 emits heat, i.e. electric energy is converted into heat energy by the electric resistance of the filament 13. This heat of the heater heats the object to be heated, as it is transferred to the outside via the tube 11.

Meanwhile, according to the present embodiment, the contact of an inner circumferential surface of the tube 11 and the filament 13 is prevented by the filament supporter 15. Therefore, the generation of the devitrification phenomenon, where a crystal is formed at the surface of the tube 11 as the heat of the filament is transferred to the tube 11, is prevented even though the filament 13 generates heat. And, by means of the prevention of this devitrification phenomenon, a heat loss caused during the heat transfer process, the heat of the heater generated by the filament 13 is transferred to the object to be heated via the tube 11, can be substantially prevented.

Hereinafter, the tube heater according to the second embodiment of the present invention will be explained in detail with reference to the accompanying drawings.

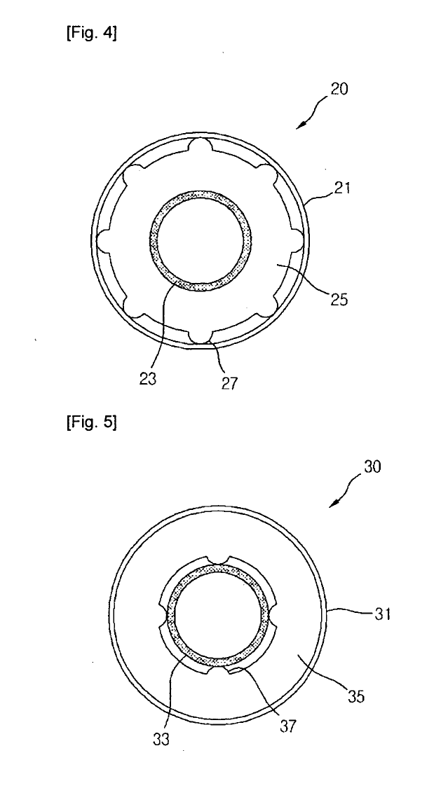

FIG. 3 shows main parts of the tube heater according to the second embodiment of the present invention in a perspective view, and FIG. 4 shows main parts according to the second embodiment of the present invention in a longitudinal cross-sectional view. In the present embodiment, the detailed explanation of the same structural elements as those explained in the first embodiment will be omitted.

Referring to FIGS. 3 and 4, in a tube heater 20 according to the present embodiment, a filament supporter 25 is disposed between an inner circumferential surface of a tube 21 and an outer circumferential surface of a filament 23 to prevent the filament 23 from being contacted to the tube 21. The filament supporter 25 may be formed of material having specific thermal resistance, for example material including ceramic.

Also, a plurality of contact projections 27 are provided at the outer circumferential surface of the filament supporter 25. The contact projections 27 serve to reduce area of contact between the inner circumferential surface of the tube 21 and the outer circumferential surface of the filament supporter 25, as it is substantially contacted to the inner circumferential surface of the tube 21. According to the present embodiment, the plurality of contact projections 27 are provided such that they are spaced apart around the center of a circle of the filament supporter 25 at a predetermined angular interval.

As described above, according to the present embodiment, the outer circumferential surface of the filament 23 is prevented from contacting to the inner circumferential surface of the tube 21 by the filament supporter 25 formed of material having thermal resistance. Also, the area of contact between the inner circumferential surface of the tube 21 and the outer circumferential surface of the filament 23 is minimized by the contact projections 27. Therefore, according to the present embodiment, since the heat of the heater generated by the filament 23 is efficiently prevented from transferring to the tube 21, the crystal formation on the tube 21 due to the devitrification phenomenon and the heat loss of the heat transfer process can be effectively prevented.

Hereinafter, tube heaters according to the third and fourth embodiments of the present invention will be explained in detail with reference to the accompanying drawings.

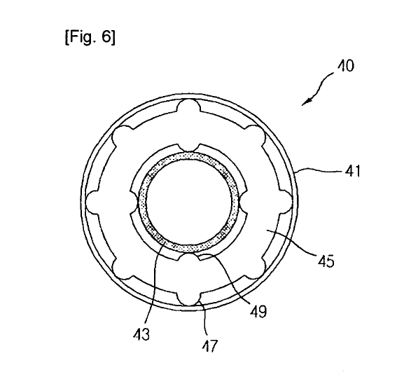

FIG. 5 shows main parts according to the third embodiment of the present invention in a longitudinal cross-sectional view, and FIG. 6 shows main parts according to the fourth embodiment of the present invention in a longitudinal cross-sectional view. In the third and fourth embodiments, the detailed explanation of the same structural elements as those explained in the second embodiment will be omitted.

Referring to FIG. 5, in a tube heater 30 according to the third embodiment of the present invention, an outer circumferential surface of a ring-shaped filament supporter 35 is contacted to an inner circumferential surface of a tube 31. And, a plurality of contact projections 37, which are to be contacted to an outer circumferential surface of a filament 33, are provided at an inner circumferential surface of the filament supporter 35. That is, according to the present embodiment, area of contact between the filament 33 and the filament supporter 35 is minimized by the contact projections 37.

Further, referring to FIG. 6, in a tube heater 40 according to the fourth embodiment of the present invention, contact projections 47, 49 are provided at inner and outer circumferential surfaces of a ring-shaped filament supporter 45, respectively. The contact projections 47 (hereinafter, referred to as ‘first contact projections’) provided at the outer circumferential surface of the filament supporter 45 are contacted to an inner circumferential surfaces of a tube 41. The contact projections 49 (hereinafter, referred to as ‘second contact projections’) provided at the inner circumferential surface of the filament supporter 45 are contacted to an outer circumferential surfaces of a filament 43. That is, according to the present embodiment, area of contact between the filament supporter 45 and the filament 43 is minimized by the first and second contact projections 47, 49.

Of course, in the third and fourth embodiments of the present invention, the filament supporters 35, 45 are preferably formed of material having specific thermal resistance. Therefore, according to the third and fourth embodiments of the present invention, the devitrification phenomenon, in which a crystal is formed at the tube 31, 41 as the heat of heater generated by the filament 33, 43, is minimized. Also, the heat loss, which is generated by the devitrification phenomenon while transferring the heat of the heater, is efficiently prevented.

It will be apparent to those skilled in the art that various modifications and variations can be made in the present invention without departing from the scope and spirit of the invention. It is intended that the present invention include such modifications and variations as come within the scope of the appended claims and their equivalents.

In the above-described embodiments, the filament supporter is formed in the shape of an approximate ring, however the present invention is not restricted thereto. For example, the filament supporter can be formed in the shape of a circular arc having a specific central angle.

1. A tube heater comprising:
a tube;
a filament which is provided in the tube and generates heat by its electric resistance; and
a filament supporter which is provided between the tube and the filament and prevents a phenomenon that heat generated by the filament is transferred to the tube, as it is formed of material having thermal resistance.

2. The tube heater according to claim 1, wherein the filament supporter is formed of material including metal of at least one of Mo and W.

3. The tube heater according to claim 1, wherein the filament supporter is formed of material including ceramic.

4. A tube heater comprising:
a tube;
a filament which is provided in the tube and generates heat by its electric resistance; and
a filament supporter having a tube contacting part which is contacted to the tube and a filament fixing part which is extended from the tube contacting part and is fixed to the filament.

5. The tube heater according to claim 4, wherein the filament is formed in a linear shape.

6. The tube heater according to claim 4, wherein the filament supporter is formed by bending one element.

7. The tube heater according to claim 4, wherein the tube contacting part is disposed between the tube and the filament.

8. The tube heater according to claim 4, wherein the tube contacting part is formed in the shape of a ring, which has an outer diameter corresponding to an inner diameter of the tube.

9. The tube heater according to claim 8, wherein the filament fixing part is extended from one side of the tube contacting part toward the center of a circle of the tube contacting part.

10. A tube heater comprising:
a tube;
a filament which is provided in the tube and generates heat by its electric resistance; and
a filament supporter where at least some of an outer circumferential surface of the filament supporter is contacted to an inner circumferential surface of the tube, and at least some of an inner circumferential surface of the filament supporter is contacted to an outer circumferential surface of the filament.

11. The tube heater according to claim 10, wherein the filament is formed in a tubular shape.

12. The tube heater according to claim 10, wherein at least one contact projection, which is contacted to the inner circumferential surface of the tube or an outer surface of the filament, is provided at the filament supporter.

13. The tube heater according to claim 10, wherein at least one contact projection contacted to the inner circumferential surface of the tube is provided at the outer circumferential surface of the filament supporter,
and wherein the inner circumferential surface of the filament supporter is contacted with the outer circumferential surface of the filament.

14. The tube heater according to claim 10, wherein the outer circumferential surface of the filament supporter is contacted with the inner circumferential surface of the tube,
and wherein at least one contact projection contacted with an outer surface of the filament is formed at the inner circumferential surface of the filament supporter.

15. The tube heater according to claim 10, wherein at least one contact projection, which is respectively contacted with the inner circumferential surface of the tube or with an outer surface of the filament, is provided at outer and inner circumferential surfaces of the filament supporter.

16. An electric hob comprising:
a casing with an opened top;
a top plate disposed on the opened top of the casing; and
a tube heater disposed inside the casing;
wherein the tube heater comprises,
a tube;
a filament which generates heat by its electric resistance; and
a filament supporter which prevents a phenomenon that heat generated by the filament is transferred to the tube.

17. The electric hob according to claim 16, wherein the filament supporter is contacted to an inner circumferential surface of the tube and an outer surface of the filament.

18. The electric hob according to claim 16, wherein at least one contact projection, which reduces area of contact between an inner circumferential surface of the tube and an outer circumferential surface of the filament supporter or/and between an outer circumferential surface of the filament and an inner circumferential surface of the filament supporter.
